(19) United States
(12) Patent Application Publication
(10) Pub. No.: US 2025/0179730 A1
(43) Pub. Date: Jun. 5, 2025

(54) METHOD AND APPARATUS FOR RECOVERING FIBRES

(71) Applicant: MDF RECOVERY LIMITED, Gwynedd (GB)

(72) Inventor: Craig George Bartlett, Gwynedd (GB)

(21) Appl. No.: 18/845,849

(22) PCT Filed: Mar. 15, 2023
(86) PCT No.: PCT/GB2023/050602

§ 371 Date: Sep. 10, 2024

(30) Foreign Application Priority Data
Mar. 15, 2022 (GB) 2203569.5

(51) Int. Cl. D21B 1/30

(52) U.S. Cl. CPC D21B 1/30

(57) ABSTRACT

An apparatus for recovering separated fibres from a biomass composite material, such as an engineered wood material, is described. The apparatus has a channel configured to receive a slurry comprising water and a biomass composite material; two or more conveyor belts configured to move the slurry through the channel, such that biomass composite material is disposed between the two conveyor belts, and a plurality of electrodes disposed within the channel, the electrodes being configured to pass an electric current through the slurry to heat the biomass composite material, to effect separation of the fibres in the biomass composite material; and to recover the separated fibres. A method for recovering separated fibres is also described.

### TECHNICAL FIELD

This invention relates to the recovery and recycling of separated fibres from biomass-composite materials, and more specifically engineered wood products such as fibreboards and particleboard. More specifically, the invention relates to a novel apparatus and method that facilitates the recovery and recycling of separated fibres using ohmic heating.

### BACKGROUND

Biomass composite materials, such as engineered wood materials, are commonly-used raw materials for a number of applications, including furniture manufacture, joinery and construction. These materials comprise a matrix of biomass fibres that are reinforced with the addition of a resin or adhesive. Prominent examples of these materials are particleboard, medium density fibreboard (MDF) high density fibre board (HDF).

Biomass composite materials are widely used and are typically cheaper, denser and more uniform than unprocessed biomass materials such as conventional wood. However, over time, these materials can be susceptible to expansion and discoloration due to moisture absorption. A significant problem is that these materials do not lend themselves readily to effective recycling, particularly MDF. Those that generate MDF based waste will typically pay upwards of £100 per tonne for its disposal. Effective recovery of MDF fibres can be extremely difficult due to the strong reactive bonding which takes place between the thermoset adhesive and functional hydroxyl groups of the biomass-composite material or lignocellulosic fibre. This means that heat alone cannot decouple the thermoset adhesive from the fibres.

There are therefore significant advantages to developing an apparatus and method that effectively separates fibres from biomass-composite material.

Previous attempts to solve this issue include crude hammer milling technology, heating the materials (e.g. with microwave radiation or steam heating), or autoclave processing. However, these methods have significant disadvantages. For example, crude hammer milling is found to generate extreme levels of dust; microwave technology is too costly in terms of energy, capital and safety; steam-heating processes typically have to be carried out at elevated temperatures and pressures (e.g., 150° C. and 15 bar), thereby having high energy and high equipment cost and complexity, and also, in certain processes, may risk damaging the fibres when moisture in and around the composite material expands while the pressure is rapidly reduced. Further, the use of autoclave processing requires the undesirable addition of chemicals (such as urea), and due to the batch nature of the process, is unsuitable for recovering materials at a large scale. To ensure high value end use for recovered fibres, a process which causes the least amount of damage to the fibres in relation to their length to diameter ratio is desirable. However, prior art processes fail to succeed in cleaving the adhesive from the fibres without causing significant damage.

EP2516730 B1 provides a method to recycle engineered wood materials using ohmic heating. However, EP2516730 B1 does not describe an efficient method of continuously moving a slurry through the reaction channel. The methods it does describe are effective, but potentially inefficient. For example, while a plug screw and displacement apparatus is described, and will work to an extent, such conveying systems are less optimum as the slurry and biomass-composite material, including MDF chips, can lead, after extended use, to the slurry blocking piping and equipment in the reaction channel after ohmic heating. While the slurry can be conveyed more effectively when highly diluted in water, in operation, a more dilute phase is more expensive to heat.

It is therefore an aim of the present invention to develop an improved apparatus and method that i) is suitable for large scale continuous processing for effective conveyance through the reaction channel, ii) can be used to convey slurries of any density, and/or iii) which is more energy efficient and economically viable.

### SUMMARY OF INVENTION

According to a first aspect of the invention, there is provided an apparatus for recovering separated fibres from a biomass composite material, the apparatus comprising:
a channel configured to receive a slurry comprising a liquid medium and a biomass composite material
two or more conveyor belts configured to move the slurry through the channel, such that biomass composite material is disposed between the two or more conveyor belts, and
a plurality of electrodes disposed within the channel, the electrodes being configured to pass an electric current through the slurry to heat the biomass composite material, to effect separation of the fibres in the biomass composite material.

According to a second aspect of the invention, there is provided a method of recovering separated fibres from a biomass composite material, the method comprising:
providing a slurry comprising a liquid medium and a biomass composite material;
moving the slurry through a channel using two or more conveyor belts, wherein the biomass composite material is disposed between the two or more conveyor belts; and
passing an electric current through the slurry while the biomass composite material is between the conveyor belts to heat the biomass composite material, to effect separation of the fibres in the biomass composite material; and
recovering the separated fibres.

According to a third aspect, is a method of the second aspect using the apparatus of the first aspect.

According to a fourth aspect, is a separated fibre so produced according to the methods of the second and third aspects.

According to a fifth aspect, there is a recycled biomass-composite material, comprising separated fibres according to the fourth aspect.

The apparatus and method described herein can be used to separate and recover the fibres from all types of biomass-composite material, including but not exclusively fibreboard and particleboard, including MDF.

The application of an electric current to a slurry comprising biomass-composite material and a liquid medium (e.g., water) leads to effective ohmic (conductive) heating of the biomass-composite material as compared to other heating methods. The application of ohmic heating leads to the physical separation between the resin and the fibres and/or the breakage of bonds between the resin(s) and the fibres in the biomass-composite material. The benefit of applying ohmic heating is the uniform and penetrative heating effect generated by this technique without burning or charring. This breaks down the resin binding the biomass fibres together in the biomass composite material, leading to the release and separation of biomass fibres. This may lead to the material expanding in size (e.g., by a factor of about 5 times).

The present apparatus and method is able to deal with the changing characteristics of the biomass-composite material as it moves through the channel, from solid pieces of composite material, to separated wood fibres. “Separated fibres” in the present context indicates that the chemical adhesion between at least some of the fibres has reduced or completely removed, such that discrete fibres have been formed. The separated fibres, while being discrete, may still form aggregated and entangled masses of fibres, which may be in the form of a spongy, compressible matrix. The separated fibres, in some embodiments, may also be physically separated. The apparatus described herein is able to cope with the continuum of states, while still allowing the reaction to progress. In particular, the two or more conveyor belts “sandwich” and physically confine the biomass-composite material, but the belts are sufficiently flexible that there is room for expansion of the biomass-composite material in the channel as the liquid medium (e.g., water) is absorbed, and the buoyancy of the material is negated by physically confining the biomass-composite material (i.e., in the slurry) between the two or more belts. The belts can continuously move the slurry through the channel while an electric current is applied through the slurry by applying voltage at the electrodes. The two or more conveyor belt system allows for variable conveying speeds and residence times throughout the channel. Additionally, the two or more conveyor belt system can also provide efficient removal of separated fibres from the channel.

The recovered fibres can be of a sufficient quality that they can be recycled into/reused into biomass-composite materials, for example, within the fibre board manufacturing industry and natural fibre insulation. The process itself is repeatable, that is, the separated and recovered fibres when used in manufactured products, are themselves recyclable. This offers environmental and economic advantages over other disposal methods such as landfilling or incineration with energy recovery, whereby the fibres and (thereby embedded carbon) are “lost” after a single cycle. The recycled fibres described herein can be cleaned in the wet phase or dry phase and therefore can be reintroduced into the MDF production process at one of several points. The recycled fibres described herein can also be sorted or graded. The recycled fibres described herein may be coated with an adhesive, e.g., a urea-formaldehyde, melamine, phenol, MDI or pDI adhesive, or not coated with an adhesive, for further use.

The apparatus and method described herein does not generate large amounts of dust, nor does the method require the use of hazardous or noxious chemicals.

The apparatus and method described herein are less energy intensive and more environmentally friendly as compared to other apparatus and methods in the art. For example, in some examples, the liquid medium can be heated and re-used in a continuous process.

The apparatus and method described herein is suitable for use with any density of slurry. Compared to prior art methods, the apparatus and method can be used with slurries having a higher amount of biomass composite material in the slurry, without causing blockages or causing the apparatus to shutdown. Unlike prior art systems that use slurries with low solids concentration and high pumping or processing speeds, the present invention is primarily used with slurries having higher solids concentrations and relatively lower processing speeds.

The processing parameters (e.g., pre-heating temperature, power or current applied, or belt speed) of the method herein can be easily adjusted depending on the desired level of processing and/or properties of the input material.

The method and apparatus are suitable for the continuous processing of high volumes of biomass fibre from manufactured products. This is significantly advantageous and more efficient compared to batch processing, with highly targeted application of energy to the targeted material.

The method and apparatus described herein is also suitable for separating finished material from the biomass fibres (i.e. material with surface finishes (e.g. veneer, metal foil paint), commonly applied to composite products). This method and apparatus described herein is suitable for processing different waste streams (i.e. finished and unfinished material or a combination thereof). The apparatus and method is also suitable from separating biomass composite material (i.e., MDF waste materials) from other biomass waste (e.g., conventional wood waste).

The method and apparatus described herein is not abrasive such that high quality fibres are recovered, with the recycled fibres having the same or similar length as the fibres that are inputted into the method and apparatus. This is therefore improved over methods that utilize pressure release (e.g., such as autoclave methods), methods that use pulping, screw conveying or steam explosion methods, since extended residence time in water or any other liquid medium can weaken the fibres.

Further, the method and apparatus described herein is capable of processing material with a high percentage of solid contaminants, such as wood or plastic, without blocking. As a result, the method and apparatus of the present invention is improved over any method and apparatus which utilises a screw or plug screw conveying system. This makes it particularly suitable for recycled consumer material.

Certain embodiments of the invention may also have one or more of the following advantages:
In certain embodiments, the distance between the two (or more) conveyor belts increases along the length of the channel. This allows further room for expansion of the material as it progresses along the length of the channel. This can be achieved by arranging a separation increase in the roller positioning, or by controlling the applied tension of the belts.
In certain embodiments, the channel is preferably sufficiently filled with a liquid medium (e.g., water), and the two conveyor belts force the biomass-composite material, held between the two conveyor belts, to be submerged in the liquid medium (e.g., water). This is advantageous because, depending on the density of the biomass-composite material, the material may otherwise have a tendency to float.
In certain embodiments, the use of non-conductive conveyor belts may be preferable since this prevents the current, formed by applying voltage at the electrodes, from substantially bypassing the slurry.
In certain embodiments, a mesh material is used for the two or more conveyor belts (or at least for one of the belts, for example, the lower belt). This has several advantages
   This enables the liquid medium (e.g., water) to pass through the conveyor belt. This can be used to wet the biomass-composite material, and/or replace the liquid medium (e.g., water) that is absorbed by the biomass composite material.
   The use of a mesh conveyor allows contaminating dust and fines to be removed, while at the same time as conveying the biomass-composite material and passing an electric current through the material in the channel. This enhances the quality of the recycled fibres.
   A mesh material enables an arrangement where the electrodes are positioned above and below the channel.
   The mesh materials described herein are preferably constructed of materials that have high tensile strength and that are capable of withstanding the high operating temperatures (e.g., up to 100° C.). A PTFE-coated Kevlar mesh is found to be particularly suitable for the construction of the mesh due to this material being lightweight, having high tensile strength, being suitable for use at high temperatures and a resistance to physical abrasion.
In certain embodiments, an automatic tensioning system is utilised to automatically adjust the tension between the two or more conveyor belts to ensure that the slurry and/or biomass-composite material is constrained between the two or more conveyor belts. This can be an pneumatic, mechanical or hydraulic tensioning system.
In certain embodiments, the apparatus comprises at least one baffle at a side of the channel between the two conveyor belts, and preferably two baffles at each of two opposing sides of the channel between the two conveyor belts. This directs the biomass composite material and/or slurry away from the edges of the conveyor belt, and reduces the likelihood that the slurry and/or biomass-composite material overflows the edges, as it expands through the channel.
In certain embodiments, the presence of an electrolyte (e.g., salt or sodium silicate) in the liquid medium (e.g., water) increases the conductivity of the slurry and/or improves heating efficiency of the slurry and biomass-composite material.
In certain embodiments, the electrodes are disposed above and below the slurry comprising a liquid medium (e.g., water) and biomass-composite material, optionally above and below the conveyor belts, such that a current can pass vertically through the slurry. Computational modelling demonstrates that increased energy efficiency can be achieved when the electrodes have this arrangement as compared to apparatus with different electrode orientations. In other embodiments, the electrodes are spaced apart laterally from one another, e.g. being disposed on or adjacent to opposing side walls to allow lateral flow of current through the slurry. Test apparatus disclosed herein with electrodes disposed at the side of the channel are demonstrated to efficiently and effectively ohmically heat biomass-composite material to effect separation of fibres.
In certain embodiments, the electrodes are arranged into at least two separate groups or arrays within the channel (i.e. the electrodes in groups or arrays contain two or more electrodes, wherein the electrodes in the groups or arrays are controlled together so that there is current flow between them). This provides greater flexibility in ohmically heating and powering the apparatus. For example, more power can be supplied to a first array of electrodes in a first portion of the channel as compared to a second array of electrodes in a second portion of the channel. This may be more energy efficient than applying the same power across the entire length of the channel. Alternatively, an uneven power distribution may give better results in terms of speed of processing the material as compared to an equal power distribution across the length of the channel.
In certain embodiments of the method, the biomass composite material is ohmically heated to a temperature between 3° and 100° C., preferably between 5° and 100° C. and preferably between 75° C. and 100° C. Ohmic heating promotes separation of the fibres in the biomass-composite material (e.g., by breakage of the chemical bonds between the resin and constituent biomass fibres), liberating the separated fibres for recovery. In certain embodiments, the biomass composite material is pre-heated prior to entering the channel. Modelling demonstrates that pre-heating of the biomass composite material prior to entering the channel can give a more energy-efficient and cost-efficient process, while providing a greater degree of control. For example, the pre-heating can be achieved using an alternative source of energy, such as gas. Further, pre-heating the biomass-composite material before it enters the channel reduces the likelihood of the biomass-composite material causing a “shock” to the system, caused by lowering the temperature of the liquid medium (e.g., water) in the channel. This pre-heating can also be efficiently incorporated into the feeding conveyors.
In some embodiments, in the method, the biomass composite is pre-shredded and mechanically broken down prior to entering the channel to aid process efficiency.
In certain embodiments, the biomass composite material and/or slurry has a depth between 5-50 cm along the length of the channel between the conveyor belts. Maintaining a steady depth of biomass-composite material ensures that the process can be more effectively controlled, with a consistent amount of electrical current being applied.
In certain embodiments, the belt speed is up to 100 mm/s, or within the range of 2 mm/s to 50 mm/s. This ensures that the slurry is continuously moved through the channel and apparatus while ensuring that the slurry and biomass-composite material has sufficient residence time in the channel and apparatus for heating in order to effect the separation of biomass fibres. The belt speed, and the residence time, can be easily varied depending on the level of processing required.
In certain embodiments, the apparatus further comprises a deagglomerating module or agitation vessel downstream of the exit of the channel. This can be used to loosen and release the fibres from any remaining tightly bound lumps or clumps of the biomass-composite material by a beating type action or mixing/stirring.
In some embodiments, the operating level of the liquid medium (e.g., water) in the channel is maintained by an automated system that continuously adds more liquid medium to the channel as it is absorbed or displaced.
In certain embodiments, the biomass composite material is an engineered wood material, for example, MDF or HDF. This is advantageous as certain fibreboards including MDF are otherwise difficult to recover and recycle.
In certain embodiments, the invention allows for subsequent processing steps to dry the fibres to varying degrees, providing flexibility and control of the moisture content of the separated and recovered fibres, thereby offering multiple entry points into the biomass composite (e.g. fibre-board) manufacturing process line which can vary between processing plants.
In certain embodiments, the apparatus disclosed herein is able to influence dewatering or removal of the liquid medium downstream of the channel, e.g., by elongating the belts such that they extend downstream of the channel, by using a certain material of belt (e.g., a mesh material), and optionally by using an elevated angle. This can reduce the energy load associated with subsequent drying or dewatering processes. Further, the dewatering process or liquid removal process also enables retention of heated liquid medium (e.g., water) within the channel, since the removed liquid medium can be recirculated back into the channel.
In further embodiments, the process can remove the adhesive binder from feedstocks that comprise synthetic fibres, mineral fibres, or a composite mixture of synthetic or mineral fibres with lignocellulosic fibres.
In further embodiments, the process as described can extract proteins and carbohydrates from biomass, acting as a pre-treatment step prior to enzyme digestion, fermentation or other biorefining process.

### BRIEF DESCRIPTION OF FIGURES

Non-limiting and non-exhaustive embodiments of the present invention are now described with reference to the following Figures

FIG. 1 shows an example apparatus according to the present invention.

FIG. 2 shows an example process according to the present invention.

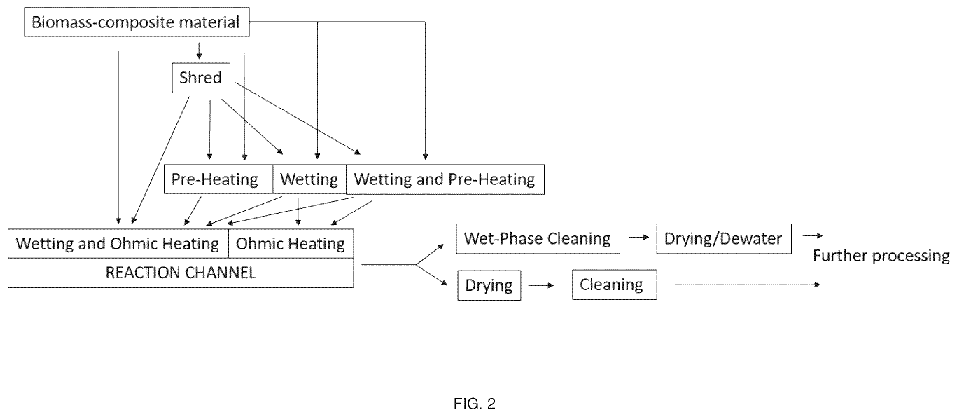

FIG. 3 shows the results of computational modelling of the heating efficiency of various arrangements of electrodes. Top) a vertical arrangement of electrodes whereby the electrodes are arranged at the side of the channel, or Bottom) a horizontal arrangement of electrodes whereby the electrodes are arranged at the top and bottom of the channel. Each graph illustrates a cross-section along the length of the apparatus, with material starting at the left and being conveyed to the right. The gray portion represents the liquid medium, while the black portion represents the slurry (biomass-composite material and liquid medium) between the conveyors. As can be observed, the horizontal arrangement illustrated by the bottom graph results in the expansion of the slurry proceeding more rapidly at the front of the apparatus, and a higher overall expansion achieved by the end of the apparatus. This is achieved with a lower power input for a comparable amount of material processed, and is hence more cost efficient.

FIG. 4 shows example photographs of A) biomass-composite material, in the form of MDF, prior to entering the apparatus and before application of the present invention method and B) separated fibres after exiting the apparatus and after application of the present invention method.

### DETAILED DESCRIPTION

Aspects of the present invention have been described above. Optional and preferred features are described below. Unless otherwise stated, any optional or preferred feature can be combined with any other optional or preferred feature, and with any of the aspects or embodiments of the invention mentioned herein unless context dictates otherwise. For example, the usage of the phrases “examples,” “example embodiments,” “some embodiments,” “embodiments,” “preferred embodiments” or other similar language, throughout this specification refers to the fact that a particular feature, structure, or characteristic described in connection with the embodiment may be included in at least one embodiment of the present invention. Thus, appearances of the phrases “in embodiments,” “example embodiments,” “in some embodiments,” “in other embodiments,” or other similar language, throughout this specification do not necessarily all refer to the same group of embodiments, but the described features, structures, or characteristics may be combined in any suitable manner in one or more embodiments.

All measurements herein are measured under standard conditions unless stated otherwise. All averages referred to herein refer to the mean average, unless stated otherwise.

If a standard test is mentioned herein, unless otherwise stated, the version of the test to be referred to is the most recent at the time of filing this patent application.

It will be readily understood that the features of the apparatus and method, as generally described and illustrated in the figures, may be arranged and designed in wide variety of different configurations. Thus, the description of the embodiments of the present apparatus and method, is not intended to limit the scope of the invention as claimed, but is merely representative of selected embodiments or examples of the invention.

As used in this specification and the appended claims, the singular forms “a,” “an,” and “the” include plural referents unless the context clearly dictates otherwise.

As used herein, the term “about” is used to provide flexibility to a numerical range endpoint by providing that a given value may be a little above or a little below the endpoint. The degree of flexibility of this term can be dictated by the particular variable and would be within the knowledge of the skilled person to determine based on experience and the associated description herein.

As used herein, the term “comprises” has an open meaning, which allows other, unspecified features to be present. This term embraces, but is not limited to, the semi-closed term “consisting essentially of” and the closed term “consisting of”. Unless the context indicates otherwise, the term “comprises” may be replaced with either “consisting essentially of” or “consists of”.

As described herein, the term “slurry” refers to a mixture of liquid medium (e.g., water) and biomass-composite material. The term encompasses wetted biomass-composite material and biomass-composite material suspended or held in a liquid medium, preferably water. In some embodiments, the liquid medium is a non-aqueous substance such as an alcohol, ether, ketone, alkyl or aromatic solvent. In other embodiments the medium is an ionic liquid. An example of a suitable ionic liquid is BMIM-PF6 (1-Butyl-3-methylimidazolium hexafluorophosphate).

As described herein “biomass-composite material” refers to a plant or animal material that has been constituted by artificially bonding plant or animal fibres together, for example, using an adhesive, glue, or resin matrix. In some embodiments, the biomass-composite material is any composite formed from or comprising plant fibres. In some embodiments, the biomass-composite material is any composite formed from or comprising lignocellulosic fibres. In some embodiments, the biomass composite material is any material that comprises lignin and one or more of an adhesive, binder, resin or glue. In some embodiments, the biomass-composite material is a wood-composite material. In some embodiments, the material may derive from, but is not limited to trees, bamboo, palm, vegetables, straw (e.g., rye straw, wheat straw, rice straw), stalks (e.g. hemp stalks, kenaf stalks), sugar cane residue, coir, coconut husk fibre or any combination thereof. An example of a biomass-composite material is an engineered wood material.

As described herein “engineered wood material” refers to material such as fibreboard and particleboard that has been constituted by artificially bonding wood fibres together, for example, using an adhesive, binder glue, or resin matrix. Engineered wood material may otherwise be referred to, or include, a wood composite material, a wood plastic composite, or manufactured board. Example engineered wood materials include medium density fibreboard (MDF), high density fibreboard (HDF) and particleboard.

As described herein, fibreboard may refer to an engineered product that is formed by breaking down lignocellulosic material (e.g., wood) into fibres (often in a defibrator), and combining the fibres with a resin and applying high temperature and/or pressure.

As described herein MDF refers to medium density fibreboard which is a fibreboard with medium density, e.g., a fibre density of between 400 and 900 kg/m³.

As described herein, HDF refers to high density fibreboard that has a high density of fibres as compared to medium-density fibreboard, and typically refers to a fibreboard with a fibre density of greater than 900 kg/m³.

As described herein softboard refers to a low density fibreboard that has a density of fibres of less than 400 kg/m³

As described herein, particleboard can refer to an engineered product that is manufactured from lignocellulosic material (e.g., wood chips) and a synthetic resin (or other suitable binder) which is pressed and extruded.

As described herein “fibre insulation board” refers to a low density fibreboard that has a density of fibres of less than 200 kg/m³ (e.g., for rigid board), or less than 80 kg/m³ (e.g., for flexible board). This fibreboard is designed to provide thermal and acoustic insulation in construction industry. The rigid and flexible terminology are commonly used terms in the construction industry indicating the degree of structural strength of the product and hence the typical application areas within a building. In some embodiments, the fibre insulation board is flexible or rigid. In preferred embodiments, the fibre insulation board comprises wood fibres and is a wood fibre insulation board. In other embodiments, the fibre insulation board comprises non-wood fibres (e.g., any other composite formed from resin and lignocellulosic fibres).

As described herein the term “to effect separation of the fibres” refers to the separation of fibres within the biomass-composite material clumps of fibre material or individual fibres. In some embodiments, the separation of fibres is in at least part caused by decoupling and/or breakage of the chemical bonds between the resin and fibres of the biomass composite material during heating. In some embodiments, the separation of fibres is in at least part caused by degradation of the resin in the biomass-composite material which was otherwise holding the fibres together.

The slurry described herein comprises a biomass-composite material and a liquid medium, preferably water. In some embodiments, the slurry consists of biomass-composite material and a liquid medium, preferably water. In other embodiments, the slurry further comprises other materials, e.g., conventional wood material. Other materials such as conventional wood would be contaminants in the process.

In the apparatus and method described herein, the slurry is conveyed through the channel, and an electric current is passed through the slurry as it conveyed along the channel. The slurry may be formed within the channel (i.e. by mixing the biomass-composite material with the liquid medium (e.g. water) in the channel) or the slurry may be formed before entering the channel (i.e. by mixing the biomass-composite material with the liquid medium (e.g., water) in a wetting module upstream of the channel).

In some embodiments, the slurry and/or biomass-composite material in the channel has a mean material depth between the two conveyor belts of from 5 cm to 50 cm, more preferably between 10 cm to 50 cm. In some embodiments, the depth of the slurry and/or biomass-composite material varies by ±25%, or ±10%, or ±5% along the entire length and width of the conveyor belt. Maintaining a steady and uniform depth of biomass-composite material between the two conveyor belts in the channel ensures that the process can be more effectively controlled, with a consistent amount of electrical current being applied.

The slurry preferably contains a high density of biomass-composite material. In some embodiments, the slurry comprises a void fraction (i.e., the amount of space between biomass-composite material) of less than 50%, preferably less than 45%, preferably less than 40%, preferably less than 35%, preferably less than 30%, or preferably less than or equal to 25% (e.g., at the entry of the channel). In some embodiments, the void fraction is between 20% and 50%, more preferably between 20% and 35%. In some embodiments, the slurry comprises the liquid medium (e.g., water) and biomass-composite material in a ratio of 8:1 to 1:1, or from 8.1 to 2.5:1, or from 7:1 to 1.5:1, or from 6:1 to 1.5:1, or 4:1 to 2:1 by weight. In some embodiments, the slurry comprises liquid medium (e.g., water) and biomass-composite material in a ratio of up to 7:1, or up to 6:1, or up to 5:1, or up to 4:1, or up to 3:1 by weight (e.g., at the entry of the channel). In some examples, for every 1 kg of dry biomass-composite material that is fed into the channel, the slurry at the entry to the channel comprises 4 kg about of liquid medium (e.g., water).

In the channel, the liquid medium (e.g., water or brine) is partly absorbed in the biomass fibres and/or fills voids between the pieces of biomass-composite material. For best results, it is desirable to maintain a dense bed of biomass-composite material disposed between the two conveyor belts that is soaked, with liquid medium (e.g., water). If the biomass-composite material (e.g. MDF) is too dilute, heating of the composite material is harder to maintain, however, if the biomass-composite material (e.g., MDF) is not wet enough, conductivity is reduced.

### Biomass Composite Material

In some embodiments, the biomass-composite material is an engineered wood material (e.g. a wood composite material) and the biomass fibres are wood fibres. The wood fibres may be aggregated in the form of particles, such as particles in chipboard or low-density fiberboard. In some embodiments, the biomass-composite material is a particleboard, fibreboard or a fibre insulation board (e.g., any lignocellulosic fibre insulation board, such as wood fibre insulation board). In some embodiments, the biomass-composite material is a fibreboard or a particleboard. In some embodiments, the biomass-composite material is a softboard, medium density fibreboard (MDF), high density fibreboard (HDF) or particleboard (i.e., otherwise known as chipboard or low density fibreboard). In some examples, the MDF is ultralight MDF plate (ULDF), moisture-resistance board, or fire retardant MDF or a combination thereof. In some embodiments, the biomass-composite material is a fibre insulation board, more preferably a wood fibre insulation board, wherein the fibre insulation board can be flexible or rigid. In other embodiments, the fibre insulation board may be a non-wood fibre insulation board (e.g., any other composite formed from resin and lignocellulosic fibres).

In some embodiments, the biomass-composite material comprises a particleboard or fibreboard in combination with a non-composite (i.e. conventional wood material). In some embodiments, the biomass-composite material is a finished biomass-composite material (i.e., comprising a surface finish or veneer), or an unfinished biomass-composite material (i.e., not comprising a surface finish or veneer). In some embodiments, the biomass-composite material further comprises one or more of plywood, oriented strand board (i.e., otherwise known as flakeboard, waferboard or chipboard), or any combination thereof. These other materials are typically contaminants in the process.

In some embodiments, the biomass-composite material, before being introduced between the conveyor belts as part of the slurry, is shredded. The biomass-composite material may be shredded in dry form, i.e., before combination with the liquid medium to form the slurry, or as part of the slurry. In some examples, before being introduced between the conveyor belts as part of the slurry, at least some of the biomass-composite material is in the form of pieces, which may be lamellar pieces. A lamellar piece is a piece having first and second dimensions of a longer length than a third dimension, each of first, second and third dimensions being perpendicular to one another. In other words, a lamellar piece is a platelet-like piece. In some examples, before being introduced between the conveyor belts as part of the slurry, the shredded biomass-composite material comprises pieces, which may be lamellar, at least some of which (preferably at least 25% by number, optionally at least 50% by number, optionally at least 75% by number) have length of between 10 to 45 mm, as measured along its longest dimension, preferably from 30 to 40 mm. In some examples, before being introduced between the conveyor belts as part of the slurry, the shredded biomass-composite material comprises pieces, which may be lamellar, having a mean length of between 25 to 45 mm, as measured along a longest dimension of a piece, preferably from 30 to 40 mm. In some examples, before being introduced between the conveyor belts as part of the slurry, the shredded biomass-composite material comprises pieces, which may be lamellar, at least some of which (preferably at least 25% by number, optionally at least 50% by number) have thickness of between 3-10 mm, as measured along the shortest dimension of a piece. In some examples, the biomass-composite material may have been shredded in a shredding step using a mechanical breakdown module which forms part of the apparatus described herein.

In some embodiments, the biomass composite material has any suitable dry density (i.e., the density prior to wetting or mixing with liquid medium (e.g., water) to form a slurry). In an embodiment, the biomass composite material has a dry density from 100 to 1100 kg/m³, or between 200 to 900 kg/m³, preferably from 450 to 900 kg/m³. In some embodiments, the dry density of the biomass composite material is greater than 100 kg/m³, or greater than 200 kg/m³, or greater than 300 kg/m³, or greater than 400 kg/m³, or greater than 500 kg/m³, or greater than 600 kg/m³, or greater than 700 kg/m³, or greater than 800 kg/m³, or greater than 900 kg/m³, or greater than 1000 kg/m³. In some embodiments, the dry density of the biomass composite material is less than 1100 kg/m³, or less than 1000 kg/m³, or less than 900 kg/m³, or less than 800 kg/m³, or less than 700 kg/m³, or less than 600 kg/m³, or less than 500 kg/m³, or less than 400 kg/m³, or less than 300 kg/m³, or less than 200 kg/m³.

In some embodiments, the biomass composite material comprises 70 to 90 wt. % biomass fibres (e.g., wood fibres), and 5 to 20 wt. % resin. In some embodiments, the biomass composite material comprises from 75 wt. % to 87.5 wt. % biomass fibres (e.g., wood fibres) and 5 to 15 wt. % resin, or from 80 wt. % to 85 wt. % biomass fibres (e.g., wood fibres) and 7 wt. % to 12.5 wt. %. resin. In some embodiments, the biomass composite material further comprises wax (e.g. in an amount less than 2 wt. %) and/or silicon (e.g., in an amount less than 0.05 wt. %). The term “resin” used herein may be used interchangeably with a glue, adhesive or binder. In some examples, the resin is urea-formaldehyde (UF), melamine-urea-formaldehyde (MUF), methylene di-isocyanate (MDI), polymeric methylene di-isocyanate (PMDI), phenol-formaldehyde (PF), or any combination thereof. In some embodiments, the resin may be a bioadhesive. A bioadhesive described herein may refer to an adhesive substance produced or obtained by a living organism. The bioadhesive may comprise or be selected from biological monomers including, but not limited to, sugars, proteins and carbohydrates.

### Liquid Medium

The slurry comprises a liquid medium. The liquid medium is preferably a conductive liquid medium. In some embodiments, the liquid medium has a conductivity greater than 1 mS/m, or greater than 10 mS/m, or greater than 100 mS/m, or greater than 200 mS/m, or greater than 300 mS/m, or greater than 400 mS/m, or greater than 500 mS/m, or greater than or equal to 600 mS/m. In some embodiments, the liquid medium has a conductivity between 100 mS/m and 1500 mS/m, or between 200 mS/m and 1000 mS/m, or between 300 mS/m and 900 mS/m, or between 400 mS/m and 800 mS/m, or from 500 mS/m to 700 mS/m. In some examples, the liquid medium is brine, which may have a conductivity that is within any of the ranges mentioned above, and, in some embodiments, a conductivity of 600 mS/m. Conductivity can be selected in relation to the dimensions of the apparatus and the processing rate required, in order that a suitable and economical electrical design can be achieved to deliver the required electrical power. For the apparatus configuration described herein, a conductivity of around 600 mS/m enables the use of commercially available electrical drive systems utilizing non-specialist components, and connection to common electrical distribution voltages.

In preferred embodiments, the liquid medium is water. In some embodiments, no additives are added to the water. In other embodiments, the water comprises an electrolyte (i.e., a salt or molecule that ionises in water). In some embodiments, the electrolyte comprises one or more of sodium, chloride, magnesium, phosphate, sulfate or calcium. In some embodiments, the electrolyte is sodium chloride, i.e., the water is brine. The use of brine (or use of any other electrolyte) improves the conductivity of the water and improves heating efficiency. In some embodiments, the electrolyte comprises sodium silicate, which may provide fire resistant properties on the fibre.

In preferred embodiments, the liquid medium (e.g., water) is free or substantially free (aside from the biomass composite material, the liquid and any electrolytes) of chemicals or chemical additives. This may include chemicals which may be harmful to the environment and/or humans or chemicals that might have a negative impact on subsequent uses of the recovered fibres, for example substances that might be detrimental to the production or performance characteristics of new MDF boards).

### Channel

The channel refers to the portion of the apparatus wherein the slurry and/or biomass-composite material is treated with electrodes to heat (i.e., ohmically heat) the biomass-composite material and/or slurry. The channel may otherwise be referred to as a reaction channel, processing region or ohmic heater. In the present invention, the slurry is moved through the channel using two or more conveyor belts, and a plurality of electrodes are disposed within the channel.

The channel is sized to give a sufficient residence time to the slurry and/or biomass composite material in the channel, and/or to ensure the distance between the electrodes (i.e. when the electrodes are located above and below the channel, or at the sides of the channel) can be operated with commonly available equipment and at suitable voltages. In some examples, the channel is 2 to 50 metres long, (preferably 5 to 25 metres long), 0.2 to 5 metres wide and/or 0.1 to 1 metres deep.

In some embodiments, the apparatus comprises multiple channels, for example, two or more channels. This may be preferable when scaling up the apparatus.

In some embodiments, the channel may comprise a pre-heating region and an electrode region, wherein the pre-heating region is upstream of the electrode region. In the pre-heating portion, the biomass-composite material is pre-heated by a suitable technique (e.g. a technique selected from hot water, which may be in liquid form or in the form of steam, and radiant heating methods, such as using a lamp, e.g. a halogen lamp), e.g., to a temperature from about 50° C. to up to 100° C., or from 60° C. to about 100° C., or from 65° C. to about 100° C., or from 70° C. to about 100° C., or from 75° C. to about 100° C., or from 80° C. to about 100° C. The electrode region comprises the plurality of electrodes within the channel. In some embodiments, the channel may comprise only an electrode region (i.e. with a pre-heating module instead located upstream of the channel). Pre-heating can lead to process improvements, including shorter residence times in the ohmic heating and/or lower power input in the ohmic heating.

In preferred embodiments, the channel is not-pressurised, i.e., the channel is at atmospheric pressure. Nevertheless, in some embodiments, the channel could be pressurised, i.e., up to 20 times atmospheric pressure (20 barg).

In use, the channel comprises a slurry comprising a liquid medium (e.g., water) and biomass-composite material. The liquid medium (e.g., water) is present in the channel such that a conductive path is available between the electrodes. In some embodiments, the liquid medium is present in the channel such that at least 70%, or least 75%, or at least 80%, or at least 85%, or at least 90%, or at least 95%, or at least 99% of the volume of the channel is filled with water, or the channel is completely filled with water. In some embodiments, the apparatus comprises an automatic top-up system (i.e., which replaces the water lost from the apparatus). It is preferred that the operating level of the water is above the upper belt of the two conveyor belt system.

The channel may be formed from any suitable material. The channel is preferably formed from a non-conductive material, for example a polymeric material, such as a polyalkylene. The material is selected such that it can withstand the operating temperatures of the method. In some embodiments, the channel is formed from a material that is heat-resistant to temperatures of at least 100° C., or at least 120° C., or at least 150° C., or at least 175° C., or at least 200° C., or at least 225° C., or at least 250° C. In some examples, the channel is formed from polypropylene.

The channel may have any suitable shape. In some embodiments, the channel is rectangular. In alternative embodiments, the channel is shaped to mimic or accommodate the profile of the two or more conveyor belts (e.g., the expansion profile of the two or more conveyor belts). In some embodiments, the channel is shaped with a top or bottom that slopes from the entry point to exit point (i.e., matching the profile of a sloping conveyor belt). In preferred embodiments, the channel is shaped with a bottom that slopes from the entry to exit point (i.e., matching the profile of a sloping lower conveyor belt).

This can allow for lower energy use as less liquid medium (e.g., water) may be required to fill the channel as opposed to a rectangular channel. Additionally, the sloping of the bottom can prevent the formation of stagnant areas of liquid medium within the apparatus and can prevent solid particles from settling on the bottom of the channel. This can be advantageous from a maintenance perspective and ensures the maximum recovery of fibres.

### Conveyor Belts

The apparatus described herein comprises two or more conveyor belts. The point at which the two or more conveyor belts feed into the channel is the entry point and the point at which the two or more conveyor belts feed out of the channel is the exit point. The two or more conveyor belts, preferably a lower conveyor belt and an upper conveyor belt, are arranged on top of one another in the channel with a spacing between the two conveyor belts (i.e. for the biomass-composite material and slurry to reside).

In use, the slurry and biomass-composite material is disposed between the two or more conveyor belts within the channel, e.g., in a sandwich arrangement such that the slurry and biomass-composite material is physically confined. The two or more conveyor belts are configured to move the slurry through the channel, by any suitable means. In some embodiments, the two or more conveyor belts are moved by rollers. In some embodiments, the rollers comprise a driven roller (e.g., one per belt) and one or more guide rollers.

In preferred embodiments, the biomass-composite material is fed into the channel via the lower belt.

The conveyor belts are configured to move at any suitable speed. The speed can be varied depending on the desired residence time of the slurry within the channel or reactor. In some embodiments, the belt speed of the two or more conveyor belts is up to 100 mm/s. In some embodiments, the belt speed of the two or more conveyor belts is between about 1 mm/s to about 75 mm/s, or about 2 mm/s to about 50 mm/s, or about 2.5 mm/s to about 20 mm/s, or about 3 mm/s to about 15 mm/s, or about 3.5 mm/s to about 12.5 mm/s, or about 4 mm/s to about 10 mm/s, or about 5 mm/s to about 9 mm/s. In some embodiments, the belt speed is greater than 1 mm/s, or greater than 2 mm/s, or greater than 3 mm/s, or greater than 4 mm/s, or greater than 5 mm/s, or greater than 6 mm/s, or greater than 7 mm/s, or greater than 8 mm/s, or greater than 9 mm/s, or greater than 10 mm/s, or greater than 15 mm/s, or greater than 20 mm/s. In some embodiments, the belt speed is less than 25 mm/s, or less than 20 mm/s, or less than 17.5 mm/s, or less than 15 mm/s, or less than 12.5 mm/s, or less than 10 mm/s, or less than 9 mm/s. The belt speed is nevertheless adjustable to account for biomass-composite material of different characteristics (e.g., density) which may alter the residence time chosen.

The two or more conveyor belts, which may comprise a lower belt and an upper belt, may be formed of any suitable material. In some embodiments, the two or more conveyor belts, e.g. lower belt and upper belt, are made of the same material as one another. In other embodiments, the two or more conveyor belts, e.g. the lower belt and upper belt, are made of a different material.

In some embodiments, the two or more conveyor belts (e.g. the lower belt and/or upper belt) are preferably made of a non-electrically conductive material. The use of non-electrically conductive belts is safer in operation and construction of the apparatus and minimizes the risk that an electrical potential being present outside the channel. Additionally, the present inventors have found that non-electrically conductive belts are advantageous as the current density and power dissipation within the process material are independent of the spacing between the two belts.

In alternative embodiments, the two or more conveyor belts could be formed of a conductive material. This could provide advantages in supplying the electrical potential directly to the slurry material. Non-electrically conductive indicates a material that has a conductivity less than water, e.g., tap water, e.g., a conductivity of 0.05 S/m or less, preferably 0.005 S/m or less, preferably 0.0005 S/m or less.

The two or more conveyor belts are preferably sufficiently strong to withstand the forces generated within the apparatus. In some embodiments, the two or more conveyor belts (i.e., the lower belt and/or upper belt) are formed of a material of high tensile strength. In some embodiments, the two or more conveyor belts are formed of a material are formed of a material having a tensile strength greater than 2000 N/5 cm, or greater than 2500 N/5 cm, or greater than 3000 N/5 cm, or greater than 3500 N/5 cm, or greater than 4000 N/5 cm, or greater than 4500 N/5 cm, or greater than 5000 N/5 cm, or greater than 5500 N/5 cm. In some embodiments, the two or more conveyor belts are formed of a material having a tensile strength of between 2500 N/5 cm to 12500 N/5 cm, or between 3000 to 8000 N/5 cm.

The two or more conveyor belts are preferably sufficiently heat-resistant to withstand temperatures within the channel. In some embodiments, the two or more conveyor belts are heat-resistant to a temperature of at least 100° C., or at least 120° C., or at least 150° C., or at least 175° C., or at least 200° C., or at least 225° C., or at least 250° C.

In some embodiments, the two or more conveyor belts (i.e. the lower belt and/or upper belt) comprise a material selected from a polymeric material and a ceramic material. In some embodiments, the two or more conveyor belts (i.e. the lower belt and/or upper belt) comprise a material selected from: an aramid, PTFE (i.e. polytetrafluoroethylene), fiberglass, polyester, PBO (polybenzobisoxazole), a rubber, a polyurethane, nylon, a nitrile, a neoprene, a polyester, a polyolefin, such as polyethylene or polypropylene. The aramid may be a para-aramid (e.g. poly(azanediyl-1,4-phenyleneazanediylterephthaloyl), sometimes commercially termed Kevlar®, available from Dupont) or a meta-aramid (e.g. a polymer formed from the monomers m-phenylenediamine and isophthaloyl chloride, sometimes commercially termed Nomex®, available from DuPont). In some embodiments, the two or more conveyor belts are formed of a coated para-aramid material, more specifically a para-aramid material coated with PTFE. Such conveyor belts have a high tensile strength and can withstand high temperatures.

At least one of the two or more conveyor belts (i.e. the lower belt and/or upper belt) is preferably made of a mesh material, more preferably a non-electrically conductive mesh material. A mesh material is described as any material comprising holes or apertures. This allows a path for the liquid medium (e.g., water) to move through the conveyor belts, e.g., to wet the biomass-composite material or to replace the liquid medium (e.g., water) absorbed by the biomass-composite material. A mesh material is also compatible with various electrode configurations, i.e., in configurations with electrodes that are placed above and below the conveyor belts, such that current is able to pass through the conveyor belts. The use of a mesh can also enable dust or fines to be simultaneously removed or separated from the separated fibres.

The mesh may have apertures of any suitable size, but is preferably sufficiently small to retain separated fibres on the conveyor belt(s). In some embodiments, the mesh may have an aperture size from about 1 to 20 mm, but more preferably between 1 to 6 mm, and even more preferably between 1 to 3 mm, wherein the aperture size is defined as the size of the diameter or longest dimension. In some embodiments, the mesh may have an aperture size of less than 6 mm, or less than 5 mm, or less than 4 mm, or less than 3 mm, or less than 2 mm. In some embodiments, the open mesh may have a mesh size of greater than 1 mm, or greater than 2 mm, or greater than 3 mm, or greater than 4 mm, or greater than 5 mm.

The mesh may have apertures with any suitable shape. In some embodiments, it is preferred that the ratio of the longest dimension of the aperture to the shortest dimension of the aperture is less than 2:1, or less than 1.5:1. In some examples, the apertures are circles or squares.

In some embodiments, the distance between the two or more conveyor belts is adaptable along the length of the channel. In some embodiments, the distance between the two or more conveyor belts (i.e., the lower belt and the upper belt) increases along the length of the channel (i.e., from the entry point to the exit point). In other words, the two or more conveyor belts diverge and/or separate as they progress along the length of the channel (i.e., from the entry point to the exit point), e.g., wherein at least one of the two or more conveyor belts slopes along the length of the channel. As a result, the distance between the two conveyor belts at the entry point of the channel is smaller than the distance between the two conveyor belts at the exit point of the channel. In some embodiments, the distance between the two conveyor belts increases by at least 20%, across the length of the channel (i.e., from the entry point to the exit point), preferably wherein the distance between the two conveyor belts increases from between 20-400% across the length of the channel. In some embodiments, the distance between the two conveyor belts at the entry point of the channel is between 25-300 mm, or from 100 to 275 mm or from 150 to 250 mm (e.g., 200 mm), and the distance between the two conveyor belts at the exit point of the channel is between 50-600 mm, or from 200-450 mm, or from 250 mm to 400 mm, or from 300-350 mm. The separation of the two conveyor belts along the length of the channel allows for expansion of the slurry as the reaction progresses (i.e, wherein the slurry is ohmically heated and the resin is degraded). In some embodiments, the distance between the two conveyor belts is increased or adapted by changing the roller positioning. In other embodiments, the distance between the two conveyor belts is increased or adapted by controlling the applied tension of the belts. In some embodiments, the apparatus further comprises an automatic tensioning system to adjust the tension between the two or more conveyor belts. In some embodiments, the distance between the two or more conveyor belts remains substantially similar along the length of channel. In some embodiments, the automatic tensioning system is a pneumatic tensioning system, a mechanical tensioning system, an electrical tensioning system or a hydraulic tensioning system.

The distance of between the entry point of the two or more conveyor belts to the exit point of the two conveyor belts in the channel may be any suitable distance (which will vary depending on the scale of the apparatus and the size of the channel). In some examples, the distance is between 1 and 20 metres, optionally 5 and 20 metres.

The two conveyor or more belts may have any suitable width (which will vary depending on the scale of the apparatus and the size of the channel). In some embodiments, the width of the belt is up to 5 metres, or from about 0.1 metre to about 5 metres, or from about 0.25 metres to 4 metres. or from about 2 metres to about 4 metres, or about 3 metres. In some embodiments, the width of the belt is greater than 1 metre, or greater than 2 metres, or greater than or equal to 3 metres, or greater than or equal to 4 metres.

The two conveyor or more belts may have any suitable thickness. In an embodiment, the two conveyor belts each independently have a thickness of from 0.5 mm to 5 mm, or 0.5 mm to 2 mm. The thickness of the belt may be selected depending on the desired tensile strength.

In some embodiments, the belt comprises flights or stiffeners to make the belt more rigid. This may be useful as the size of the apparatus and belt increases. Furthermore, flights can also aid processing by helping move the biomass-composite material through the channel, and can eliminate slippage whereby the two conveyor belts move while leaving the material behind. Additionally, or alternatively, in some embodiments, the apparatus may comprise rollers to support the belt.

In some embodiments, the two or more conveyor belts raise the separated fibres out of the channel for delivery to the next processing step (e.g. to the drying module, deagglomerating module and/or cleaning module).

In some embodiments, the two or more conveyor belts are formed of a mesh material and further comprise an elongated section downstream of the channel to allow water to drain from the separated fibres. In some embodiments, the elongated section is elevated. In some embodiments, apparatus further comprises a compression means, e.g., a mechanical press, arranged to compress the elongated section to effect water drainage. This may be beneficial since at the exit of the channel, the separated fibres may comprise a high proportion of water, e.g., up to 6 times the mass of the separated fibres. Further benefits of this water drainage process is that dissolved contamination can be removed instead of being carried forward to subsequent processing steps. In some embodiments, the apparatus comprises a means for returning drained water to the channel (e.g., by a water circulation unit disclosed herein). This may be beneficial for returning electrolytes and heat to the channel.

In an embodiment, the apparatus may include a belt-cleaning system. The belt-cleaning system may remove biomass and/or any other material from the belt after the biomass has been ohmically heated. The belt-cleaning system may be located toward the opposite end of the channel from which the biomass is introduced into the channel. A belt-cleaning system can act to improve fibre recovery rates when using the apparatus.

### Electrodes

The apparatus comprises a plurality of electrodes disposed within the channel. The electrodes are disposed within the channel at any suitable position such that they are configured to pass current through the slurry and biomass-composite material to heat (i.e., ohmically heat) the biomass-composite material.

A plurality of electrodes described herein includes any suitable number of electrodes. In some embodiments, the plurality of electrodes may comprise at least two electrodes, or at least four electrodes, or at least six electrodes, or at least eight electrodes, or at least ten electrodes, or at least 20 electrodes, or at least 30 electrodes.

In some embodiments (e.g., in a non-pressurised system), the electrodes are configured to heat the slurry and/or maintain the temperature of the slurry to a temperature of between 50° C. to 100° C., or from 60° C. to 100° C., or from 65° C. to 100° C., or from 70° C. to 100° C., or from 75° C. to 100° C., or from 80° C. to 100° C. In some embodiments, the electrodes are configured to heat and/or maintain the temperature of the slurry to a temperature of at least 50° C., or at least 60° C., or at least 65° C., or at least 70° C., or at least 75° C., or at least 80° C. Higher temperatures may facilitate the breakage of bonds between the resin and constituent fibres in the biomass-composite material and/or facilitate breakdown of the resin present in the biomass composite material. In some embodiments, (e.g., in a pressurised system) the electrodes are configured to heat the slurry and/or maintain the temperature of the slurry to a temperature of up to 200° C.

In some embodiments, the electrodes are arranged such that a first electrode is spaced apart from a second electrode to allow the slurry to pass between the first and second electrodes and the electric current to pass between the first and second electrodes, wherein, in use, the first and second electrodes are disposed at different vertical heights within the channel and/or the first electrode is spaced apart laterally in the channel from a second electrode. A plurality of first electrodes may be provided, e.g., in the form of an array. A plurality of second electrodes may be provided, e.g., in the form of an array.

In some embodiments, the first and second electrodes are disposed at different vertical heights (e.g., above and below the slurry). It has been found that, in embodiments in which the first and second electrodes are disposed at different vertical heights, such that an electrical current passes in a substantially vertical direction, this has efficiency advantages over embodiments in which they are spaced apart laterally (i.e., along a horizontal direction). In some embodiments, the electrodes are disposed above and below the two or more conveyor belts (i.e., for a horizontal conveyor), i.e., such that the conveyor belts are disposed between first and second electrodes, to allow electrical current to pass through the conveyor belts and through the slurry between them. In the embodiments described above, the first and second electrodes may be of a single phase and neutral electrical supply or may be of two phases of a multi-phase supply. The electrodes may further comprise a further electrode or electrode array, e.g., a third and fourth electrode (or third and fourth electrode array), allowing connection to three phase or three phase and neutral electrical supplies found in typical industrial environment, or indeed to any number of electrodes and phases as may be conceived for the electrical supply.

For the above arrangement of electrodes, the two or more conveyor belts are of a suitable material to allow current to pass through the conveyor belts (e.g., conductive material or an open mesh conveyor). Modelling suggests increased energy efficiency is observed when the electrodes are positioned in this manner. The electrodes are preferably positioned outside the at least the two or more conveyors at a minimal practical distance from the slurry and/or biomass-composite material to be processed. In such embodiments, the vertical distance between first and second electrodes disposed at different vertical heights is about 0.1 to 1 metres. In preferred embodiments, the electrodes span at least 70% of the width of the two or more conveyor belts, or at least 75%, or at least 80%, or about 85%, or about 90%, or about 95%, or about 99%, or the electrodes span 100% of the width of the two or more conveyor belts. This allows the material being processed to receive a uniform heat input and at the same time as the slurry is conveyed through the channel.

In alternative embodiments, the electrodes or electrode arrays (e.g., the first and second electrodes or arrays) are disposed laterally, e.g., on opposing side walls of the channel, i.e., with the first electrode(s) on a side wall, and the second electrode(s) on an opposing side wall, to allow slurry to pass between them and an electrical current to be passed through the slurry. As demonstrated in the example method, electrodes disposed in an apparatus at either side of the channel can be used to effectively heat a slurry comprising biomass-composite material and water, in order to effectively separate and recover fibres from the material. In such embodiments, the distance between the electrodes at either side of the channel may be about 0.3 to about 5 metres.

In preferred embodiments, the electrodes span at least 70% of the distance between the two or more conveyor belts, or at least 75%, or at least 80%, or about 85%, or about 90%, or about 95%, or about 99%, or the electrodes span 100% of the distance between the two or more conveyor belts. This allows the material being processed to receive a similar heat input and at the same time as the slurry is conveyed through the channel.

In some embodiments, the first and second electrodes are disposed at different vertical heights within the channel and the and first electrode is spaced apart laterally in the channel from a second electrode, i.e. in use, some electrodes may be disposed above and below the slurry and some electrodes are disposed at either side of the slurry. This allows current to be passed vertically and/or laterally through the slurry.

In preferred embodiments, the electrodes are positioned at different points along at least a part of the length of the channel between the exit point and entry point of the conveyor belts. In some embodiments, the electrodes are positioned along a portion of the channel between the exit point and entry point of the conveyor belts. This may otherwise be referred to as the electrode region herein or L_{electrode}, wherein the electrode region is defined as the region spanning from the first electrode to the last electrode.

In some embodiments, the electrode region spans over 40%, or over 45%, or over 50%, or over 55%, or over 60%, or over 65%, or over 70%, or over 75%, or over 80%, or over 85%, or over 90%, or over 95% of the distance between the entry point and the exit point of the two or more conveyor belts. In some embodiments, the electrode region spans the entire length of the channel (i.e., the first electrode(s) are disposed at (or substantially near to) the entry of the channel, and the last electrode(s) are disposed at (or substantially near to) the exit of the channel). In some embodiments, the electrode region is at least 3 metres in length, or at least 4 metres, or at least 5 metres, or at least 6 metres, or at least 7 metres, or at least 8 metres in length.

In some embodiments, at least some of the electrodes are present near the entry point of the channel, i.e., at least some of the electrodes are present within 2 metres of the entry point, or within 1.5 m, or within 1 metre, or within 75 cm, or within 50 cm, or within 25 cm, or within 10 cm of the entry point. It is advantageous to apply ohmic heating to the slurry as close to the entry of the channel as possible because heating is used to raise the temperature of the material being processed, which in turn facilitates the breakdown of resin present in the biomass-composite material and/or breaks the bonds between the resin and the fibres. In some embodiments, the electrode region follows a pre-heating region within the channel.

In some embodiments, the electrodes are arranged into at least two groups along the length of the channel, each group comprising a plurality of electrodes (e.g., an group of first electrodes and an group of second electrodes). The at least two separate groups may be configured to pass different levels of current through the slurry along the length of the channel. In some embodiments, there are at least three separate groups along the length of the channel, or at least four, or at least five, or at least six, or at least seven, or at least eight, or at least nine, or at least ten separate groups along the length of the channel. Using such groups enables different applications of current along the length of the channel and gives greater flexibility in terms of processing control. In some embodiments, in use, the current applied to a first group of electrodes (e.g., located in a first portion of the channel) is greater than the current applied to a second group of electrodes (e.g., located in a second portion of the channel downstream of the first portion of the channel).

In some embodiments, there is spacing between the electrodes which are arranged in series along the length of the channel, or along part of the length of the channel (i.e., between the entry point and exit point of the two or more conveyor belts). With spacing between the electrodes, this means that the slurry therefore passes through regions of relatively higher or lower heat input. In such embodiments, the electrode spacing is therefore suitably selected such that the heating remains relatively consistent and controllable heating is achieved overall. In some embodiments, the spacing between electrodes along the length of the channel is from 0-4000 mm, preferably from 30-500 mm. In other embodiments, the electrodes are arranged continuously in series such that there is no spacing between the electrodes.

The electrodes can have any suitable shape. In an embodiment and examples, the electrodes are in the form of a plate. In other embodiments, rod-shaped electrodes may be used. Rod-shape electrodes have good contact with water in the apparatus thereby reducing the current concentration near to the electrode, which can lead to more consistent heating.

The electrodes may have any suitable size. In some embodiments, the electrodes have a size of 1,000-10,000 mm².

The electrodes may be formed of any suitable conductive material. In some embodiments, the electrodes are formed of a metal or conductive carbon. In some embodiments, the electrodes are formed of steel (e.g. stainless steel), copper, titanium, gold, palladium, platinum, brass, silver, nickel, graphene, carbon nanotubes, or tungsten. In example apparatus, steel and titanium-coated electrodes have been found to work efficiently. Steel electrodes are particularly easy to machine and are affordable.

In use, a potential difference is applied to the electrodes to produce an electric current that flows through the slurry. The potential difference may produce a direct current (DC) or an alternating current (AC) through the slurry. In preferred embodiments, an alternating voltage is applied to the electrodes. This may prolong electrode life and reduces the evolution of gases at the electrodes that may be caused by the electrolysis of water or brine.

In some embodiments, the apparatus further comprises a power supply. The power supply may be any suitable power supply. In some embodiments, the power supply is a single-phase AC power supply, which can provide more uniform heating. In other embodiments, the power supply is a three phase power supply, which may be useful for higher power installations. In some embodiments, the apparatus comprises thyristors, inverters or Solid State Relays (SSRs) for optimised power delivery. In some embodiments, the apparatus further comprises a more complex power supply system, for example, wherein the apparatus comprises waveform and voltage adjusting devices. These can cost effectively deliver the required power to the apparatus, limit the impact of electrical noise on the supply system, and match or convert the available mains utility supply to that required by the apparatus.

In some embodiments, a power between about 1 KW to about 1500 KW, optionally between about 10 KW to about 1500 kW, optionally between about 20 KW to about 1500 KW can be supplied to the electrodes. This may be between about 1 KW to 100 KW, optionally 10 KW to 100 KW, optionally 20 kW to 100 KW, or between 25 KW to 75 KW, or between 40 KW to 60 kW, or about 50 KW for a small installation, and up to 1500 KW for a larger installation. In some embodiments, the voltage applied at the electrodes is between 100 and 450 V.

### Baffles

In some embodiments, the apparatus comprises at least one baffle at the edge of channel between the two or more conveyor belts. Preferably, the apparatus comprises two baffles at either edge of the channel between the two or more conveyor belts. In some embodiments, the at least one baffle or two baffles are present solely at the entry point of the channel.

The baffles(s) direct the biomass composite material and/or slurry away from the edges of the conveyor belt. This reduces the likelihood that the material, as it expands along the length of the channel, overflows the edges.

### Upstream of the Channel

The apparatus may comprise further components or modules upstream of the channel, e.g., to pre-process the biomass-composite material. Transportation between different parts of the apparatus may be by standard industrial screw or flat bed conveyors.

In some embodiments, the apparatus comprises a mechanical breakdown module located upstream of the channel. The mechanical breakdown module can be used for shredding the biomass-composite material, to break down the biomass composite material into pieces of a smaller and more uniform size. This allows for greater surface area of the biomass-composite material to be exposed for water when wetted to form a slurry. In some examples, the shredded biomass-composite material is in the form of lamellar pieces, e.g., having the sizes mentioned above. This allows for greater surface area of the material to be exposed to the water in the slurry. In some embodiments, downstream of the mechanical breakdown module, but upstream of the channel is a storage vessel for storing the shredded biomass-composite material. The storage vessel may be in the form of a silo.

In an embodiment, downstream of the mechanical breakdown module (if present) but upstream of the channel, the apparatus comprises an automated sieve. The automated sieve may be in the form of a mesh conveyor which optionally employs a degree of vibration, to remove dust and fines. In some embodiments, e.g., when the two or more conveyor belts in the channel are formed of an open mesh material, there is no automated sieve upstream of the channel because the dust and fines can be removed within the channel.

In an embodiment, the apparatus further comprises an induction magnet located upstream of the channel and downstream of the mechanical breakdown module (if present). This can be used for removing magnetic (e.g., ferrous) metals or magnetic metal contaminants.

In an embodiment, the apparatus further comprises an eddy current separator located upstream of the channel and downstream of the mechanical breakdown module (if present). This can be used for removing non-magnetic contaminants (e.g., screws, nails, fixings, hinges and other inserts that may form of manufactured goods waste).

In some embodiments, the apparatus further comprises one or more heating modules upstream of the channel and downstream of the mechanical breakdown module (if present) apparatus. The one or more heating modules can be used to pre-heat the slurry, biomass composite material and/or liquid medium (e.g., water or brine) prior to entering the channel. This accelerates the separation of the fibres when in the channel and/or reduces energy consumption. In some embodiments, the heating module uses excess heat from the other parts of the apparatus (i.e., from the reaction channel) to pre-heat the slurry, liquid medium water and/or biomass-composite material. In some embodiments, (e.g., in a non-pressurised apparatus) the one or more heating modules are configured to pre-heat the slurry, biomass composite material and/or liquid medium (e.g., water) to a temperature between 30° C. to 100° C., preferably between 50° C. and up to 100° C., more preferably 75° C. and up to 100° C., or or between 75° C. and 95° C., or between 75° C. and 90° C., or between 75° C. and 85° C. In some embodiments, the one or more heating modules are configured to pre-heat the slurry, biomass composite material and/or liquid medium (e.g., water) to a temperature of at least 30° C., or at least 40° C., or at least 50° C., or at least 60° C., or at least 70° C., or at least 75° C., or at least 80° C. In some embodiments, (e.g., in a pressurised apparatus), the one or more heating modules are configured to pre-heat the slurry, biomass-composite material and/or liquid medium (e.g., water) to a temperature of up to 200° C.

In some embodiments, the apparatus comprises insulation (e.g., surrounding the channel) to prevent unwanted heat loss and retains heat for circulation.

In an embodiment, the apparatus comprises a wetting module upstream of the channel and downstream of the mechanical breakdown module (if present). The wetting module may be in the form of a wetting tank. The wetting module comprises the liquid medium (e.g., water) and the purpose of the wetting tank is to form the slurry and to wet the biomass-composite fibres prior to entering the channel. The wetting module can be used to pre-wet the biomass-composite material before it enters the channel, e.g., to form the slurry. In some embodiments, the wetting module may be configured to heat the liquid medium (e.g., water), and in some embodiments, the wetting module may be integral with the heating module.

In some embodiments, the apparatus does not comprise a wetting module upstream of the channel. This may be in situations where the biomass-composite material is instead wetted to form a slurry within the channel.

In some embodiments, the apparatus further comprises a feed system for feeding the biomass-composite material and/or slurry onto the lower belt of the two conveyor belt system. Examples may include a storage vessel and autofeed; a rotating release valve, screw conveyor feed (e.g., for dry biomass-composite material entering the channel), a pneumatic feed system, or scraper action for vertical feed (e.g., a levelling bar). The feed system can be used to ensure a uniform and even distribution of the biomass-composite material on the lower belt (i.e., first belt) of the conveyor. The feed system can be used to ensure a steady depth of material (i.e., between 5-50 cm of slurry or biomass-composite material such that the process can be efficiently controlled).

In some embodiments, the apparatus further comprises a liquid medium-feed system (e.g., a water-feed system) for feeding liquid medium (e.g., water) into the channel. The liquid medium-feed system may comprise a dosing pump and/or a conductivity controller. The liquid medium fed into the channel can be used to replace liquid medium that is absorbed into the biomass-composite material and/or can be used to flood the channel.

In some embodiments, the apparatus further comprises a recirculation unit (e.g., a water recirculation unit) for circulating liquid medium (e.g., water) into and out of the channel. The apparatus may circulate the liquid medium at a rate up to 5 m³/hr.

In some embodiments, the recirculation unit can be used to heat and/or maintain the temperature of the apparatus (thereby reducing energy consumption). This may be useful to prevent the liquid medium (e.g., water) from becoming excessively hot due to heat generated by current flow in the liquid medium as compared to heat generated in the biomass-composite material to be processed. In some embodiments, the water recirculation unit may comprise a filtering system. This can be used to filter the liquid medium, (e.g., to filter out the resin and/or to clean the liquid medium).

Additionally and alternatively, the liquid medium circulation unit (e.g., water recirculation unit) is configured to re-circulate liquid medium that is removed during the drying process (e.g., during mechanical compression) back into the channel. This may be useful to return heat to the channel and/or apparatus. This is also useful for recovering and reusing liquid medium such that the apparatus is operated in a more sustainable and environmentally friendly manner.

Additionally or alternatively in other embodiments, the liquid medium recirculation unit (e.g., water recirculation unit) can be used for purging the channel of solids and dissolved contaminants.

In some embodiments, the apparatus may further comprise a filter or screen. In the case of solids, where these comprise largely of wood fibres that have escaped from containment between the conveyor belts, these solids can be recovered in a filter or screen to improve the overall fibre recovery from the apparatus.

In some embodiments, the apparatus further comprises a near-infra red (NIR) (or other machine vision camera) separating system upstream of the channel. This may allow contaminant materials to be identified and ejected from the incoming feedstock. This may increase the purity of the material to be processed.

### Downstream of the Channel

The apparatus may comprise further modules downstream of the channel. Transportation between the channel and different parts of the apparatus downstream of the channel may be by standard industrial screw or flat bed conveyors. In some embodiments, the apparatus comprises a double belt wire or mesh press downstream of the channel for dewatering. In some embodiments, the apparatus may include a dewatering apparatus, e.g. a plug screw dewatering apparatus, located downstream from the channel. In some embodiments, the biomass is dewatered, following ohmic heating, e.g. downstream of the channel, such that the water content is 70 wt % or less, preferably 60 wt % or less, 60 wt % or less. By dewatering (e.g. mechanically using a dewatering apparatus), this can minimise energy consumption in any evaporative heating process. In some embodiments, the apparatus may further comprise one or more of a deagglomeration module, a cleaning module, or drying module downstream of the channel. In some embodiments, the deagglomeration module, cleaning module, and drying module are separate modules. In other embodiments, one or more of the deagglomeration module, a cleaning module, or drying module are integrated into one module.

In some embodiments, downstream of the channel, the apparatus may further comprise a deagglomeration module for declumping or deagglomerating the separated fibres. The deagglomeration means may be in the form of an agitation vessel or a rotating cylinder that is optionally warmed. The deagglomeration means may comprise an airflow system which achieves the effect of liberating fibres from the remaining clumps. In other embodiments, the deagglomeration means may comprise a mechanical agitation means, for example, an in-line ribbon blender module.

In an embodiment, downstream of the channel is a cleaning module. In some embodiments, the cleaning module is in the form of a flotation separation device. In additional or alternative embodiments, the cleaning module may comprise an air separation device such as a cyclonic separator which may be used to remove non-fibrous or non-conforming contaminants. This may be used to allow the heavier and denser particles to be removed from the separated fibres (i.e., while retaining the lighter fibres).

In an embodiment, downstream of the channel of the apparatus is a drying module to dry and/or drain the recovered fibres. In some embodiments, the drying means comprises a component that effects drying by pressing or blowing. This is preferred over drying means that are effected solely by evaporation due to their much lower energy demand. In some embodiments, the drying module is in the form of a mechanical press. In some embodiments, the drying means is in the form of a high pressure nozzle. In some embodiments, the mechanical drying achieves a moisture content of less than 500 g liquid medium (e.g., water) per 1 kg of fibres. In some embodiments, the drying module alternatively or additionally comprise a component that effects drying by evaporation. In some embodiments, the drying module comprise a ring dryer, flash dryer, rotary dryer or a fluidised bed dryer. In some embodiments, the drying by evaporation achieves a moisture content of less than 150 g liquid medium (e.g., water) per 1 kg of fibres, more preferably less than 100 g of liquid medium (e.g., water) per 1 kg dry fibres.

In an embodiment, downstream of the channel, the apparatus further comprises a processing plant for manufacturing biomass-composite goods from the separated and recovered fibres. For example, when the biomass-composite material is MDF, the processing plant is an MDF production line. In some embodiments, the MDF production line is free of a refinery. It is the preferred solution for the separated fibres to be integrated after the refining step of standard MDF manufacture. This avoids the most energy intensive operations of the process and ensuring that fibre shortening/degradation in the refiner is avoided.

In an embodiment, downstream of the channel, the apparatus further comprises a processing plant for manufacturing fibre insulation board, e.g., wood fibre insulation board. The fibre insulation board may be flexible or rigid insulation board.

### Method

The method of the present invention can be carried out using the apparatus as described herein.

The method comprises providing a slurry comprising a liquid medium (e.g., water) and a biomass composite material. In some embodiments, the slurry is provided by mixing the biomass-composite material and liquid medium (e.g., water), in other words, by wetting the biomass-composite material. In some embodiments, the mixing and/or wetting takes place prior to entering the channel, for example, in a wetting module upstream of the channel. In other embodiments, the mixing and/or wetting takes place within the channel, for example, by feeding the biomass-composite material into the channel and wetting the biomass-composite material with liquid medium (e.g., water) in the channel.

In some embodiments, prior to providing the slurry, the biomass composite material maybe shredded in a shredding step. In some embodiments, the biomass composite material is shredded into pieces, which may be lamellar pieces, at least some of which (preferably at least 25% by number, optionally at least 50% by number, optionally at least 75% by number) have length of between 10 to 45 mm, as measured along its longest dimension, preferably from 30 to 40 mm. In some embodiments, the biomass composite material is shredded into pieces, which may be lamellar pieces, having a mean length of between 25 to 45 mm, as measured along a longest dimension of a piece, preferably from 30 to 40 mm. In some embodiments, the biomass composite material is shredded into pieces, which may be lamellar pieces, at least some of which (preferably at least 25% by number, optionally at least 50% by number) have thickness of between 3-10 mm, as measured along the shortest dimension of a piece.

In some embodiments, prior to providing the slurry, the biomass composite material is treated with an induction magnet and/or an eddy current separator to remove contaminants.

In some embodiments, prior to providing the slurry, the biomass-composite material and/or water is pre-heated, e.g., in a heating module upstream of the channel. In some embodiments, the biomass-composite material, liquid medium (e.g., water) and/or slurry is heated to a temperature between 50° C. and up to 100° C., or between 75° C. and up to 100° C., or between 75° C. and 95° C., or between 75° C. and 90° C., or between 75° C. and 85° C. In some embodiments, providing the slurry (i.e., wetting the biomass-composite material) and the pre-heating takes place in an integrated process.

In some embodiments, after providing the slurry (i.e., after wetting the biomass-composite material) but before moving the slurry through the channel, the slurry is heated, e.g., in a heating module upstream of the channel. In some embodiments, the biomass-composite material, liquid medium (e.g., water) and/or slurry is heated to a temperature between 50 and up to 100° C., or between 75° C. and up to 100° C., or between 75° C. and 95° C., or between 75° C. and 90° C., or between 75° C. and 85° C. In some embodiments, the heating is carried out at atmospheric pressure.

In the method of the present invention, the slurry is moved through the channel by way of the two or more conveyor belts, wherein the biomass-composite material is disposed between the two or more conveyor belts. In some embodiments, the biomass-composite material is present between the two or more conveyor belts at a depth of from 5 cm to 50 cm. In some embodiments, the biomass-composite material is present between the two conveyor belts at a depth of at least 5 cm, or at least 10 cm, or at least 15 cm, or at least 20 cm, or at least 25 cm, or at least 30 cm, or at least 35 cm. In some embodiments, the biomass-composite material is present between the two conveyor belts at a depth of less than 50 cm, or less than 45 cm, or less than 40 cm, or less than 35 cm, or less than 30 cm, or less than 25 cm, or less than 20 cm, or less than 15 cm, or less than 10 cm.

In some embodiments, the belt speed of the two or more conveyor belts is up to 100 mm/s, or within a range from 2 mm/s to 50 mm/s, in some embodiments from 3 mm/s to 15 mm/s, in some embodiments from 4 mm/s to 10 mm/s, in some embodiments from 5 mm/s to 8 mm/s. In some embodiments, the belt speed of the two or more conveyor belts is at least 2 mm/s, or at least 3 mm/s, or at least 4 mm/s, or at least 5 mm/s, or at least 6 mm/s, or at least 7 mm/s, or at least 8 mm/s. In some embodiments, the belt speed of the two or more conveyor belts is less than 20 mm/s, or less than 19 mm/s, or less than 18 mm/s, or less than 17 mm/s, or less than 16 mm/s, or less than 15 mm/s, or less than 14 mm/s, or less than 15 mm/s, or less than 14 mm/s, or less than 13 mm/s, or less than 12 mm/s, or less than 11 mm/s, or less than 10 mm/s, or less than 9 mm/s, or less than 8 mm/s, or less than 7 mm/s, or less than 6 mm/s, or less than 5 mm/s, or less than 4 mm/s, or less than 3 mm/s.

In some embodiments, the slurry has a residence time in the channel of at least 2 minutes, or at least 3 minutes, or at least 4 minutes, or at least 5 minutes, or at least 6 minutes, or at least 7 minutes, or at least 8 minutes, or at least 9 minutes, or at least 10 minutes, or at least 12.5 minutes, or at least 15 minutes, or at least 17.5 minutes, or at least 20 minutes, or at least 30 minutes, or at least 40 minutes, or at least 60 minutes, or at least 120 minutes. In some examples, the residence time is about 15 to 45 minutes. Denser materials may require longer residence times and may take longer to process.

In some embodiments, the biomass-composite material is moved through the channel at a rate of 200 kg per hour to 10 tonnes per hour. In some examples, the biomass-composite material is moved through the channel at a rate of between 2.6 to 3.1 tonnes per hour. In some examples, the method can be run at least 400 kg/hr, which has been found, in some circumstances, to be very cost-effective.

The method involves passing an electric current through the slurry to heat the biomass composite material, to effect separation of the fibres in the biomass composite material. The heating of the biomass composite material by electric current may otherwise be described as ohmic heating. In some embodiments (e.g., in a non-pressurized apparatus), the biomass-composite material, water and/or slurry is heated to or maintained at a temperature of between 50° C. and 100° C., or between 6° and 100° C., or between 75° C. and 100° C., or between 75° C. and 90° C., or between 75° C. and 85° C. in the channel. The chemical bonds between the resin and fibres within the biomass-composite material can be degraded during this process, and/or the resin material is degraded, leading to separation of biomass fibres.

In other embodiments (e.g., in a pressurized apparatus), the biomass-composite material, water and/or slurry is heated to or maintained at a temperature of up to 200° C.

In preferred embodiments, the heating is carried out at atmospheric pressure. In other embodiments, the method may comprise the use of elevated pressures in the channel. embodiments, the heating is carried out above atmospheric pressure, e.g., up to 20 barg.

In some embodiments, the passing of an electric current is achieved by applying a voltage at the electrodes disposed within the channel. In some embodiments, the voltage applied is between 100 and 450 V, for example, between 200 V and 450 V, or 240 V±25 V or 400 V±25 V.

In some embodiments, the total power applied to the electrodes is between 1 KW to 1500 kW, optionally between 10 KW to 1500 KW, optionally between 20 KW to 1500 KW, or between 1 KW and 1000 KW, optionally between 10 KW and 1000 KW, optionally between 20 KW and 1000 KW, or between 1 and 500 KW, optionally between 10 and 500 KW, optionally between 20 and 500 KW, or between 1 and 100 KW, optionally between 10 and 100 KW, optionally between 20 and 100 KW, or between 25 KW and 75 KW, or about 40-50 KW. In some embodiments, the electrodes are segregated into one or more arrays within the channel, and the power supplied to an array of electrodes in the first portion (or half) of the channel is greater than the power supplied to an array of electrodes in a second portion (or half) of the channel. In some embodiments, at least 55%, or at least 60%, or at least 65%, or at least 70%, or at least 75% of the power is supplied to the array of electrodes in the first portion (or half) of the channel.

In some embodiments, the energy per unit mass of biomass-composite material is between 20 kWh/tonne to about 500 kWh/tonne. Depending on the level of processing, the energy per unit of biomass-composite material can be increased or decreased.

After moving the slurry through the channel and passing an electrical current through the slurry, the separated fibres are recovered. In some embodiments, the separated fibres are recovered after exiting the channel. In some embodiments, the separated fibres are subject to one or more of deagglomeration, cleaning or drying after exiting the channel (i.e., in a deagglomeration, cleaning or drying module), before recovering the separated fibres.

In some embodiments, the separated fibres are subjected to a wet cleaning process after exiting the channel. In some examples, the wet phase cleaning comprises diluting the separated fibres in water. (e.g., wherein the water comprises between 2 wt. % and 20 wt. % solids). The separated fibres may then be subjected to a mechanical agitation process (e.g. to further separate and/or deagglomerate the fibres). The separated fibres can then be screened using one or more filters to remove contaminants. In some embodiments, the separated fibres are then subject to a drying process, e.g., in a drying module, e.g., using a mechanical press.

In alternative embodiments, the separated fibres are subjected to a dry cleaning process after exiting the channel. This allows for appropriate storage and transportation of the recovered fibres and avoids biological degradation of the recovered fibres after production. Dry cleaning also facilitates flexibility to address multiple end markets for the recovered fibres, many of which are dry manufacturing environments. In a dry cleaning process, the separated fibres are dried, e.g., using a mechanical press and/or using ring dryers, flash dryers, rotary dryers, or fluidised bed dryers. The separated fibres are then cleaned, e.g., using a cyclone separator or a series of separators. This enables the heavier and denser particles to be removed from the air stream while retaining lighter biomass fibres.

The recovered fibres may be used for further processing. In some methods, the separated and recovered fibres are sent to a processing plant for the production of recycled biomass-composite materials, e.g., for recovered wood fibres, they may be sent to an MDF production plant.

### Separated/Recovered Fibres

According to a fourth aspect, is a separated fibre so produced according to the methods disclosed herein. The separated fibres may otherwise be referred to as recycled or recovered fibres or rMDF. For example, where the biomass-composite material is MDF, the recovered fibres are recycled MDF fibres. In some aspects, the separated fibres may be used in the fibre board manufacturing industry. In other aspects, the separated fibres may be used in insulation materials, as fillers for plastic or cement composites, as spill absorbents or in horticultural growth media.

In some embodiments, the separated fibres may be a mass of fibres. In other embodiments, the separated fibres may be individual fibres.

### Recycled Biomass-Composite Material

According to a fifth aspect, there is recycled biomass-composite material, comprising or formed using the separated fibres (or recycled fibres) disclosed herein.

The recycled biomass-composite material may be an engineered wood material, such as, a fibreboard or particleboard. In some embodiments, the recycled biomass-composite material is MDF.

### EXAMPLES

### Example Apparatus

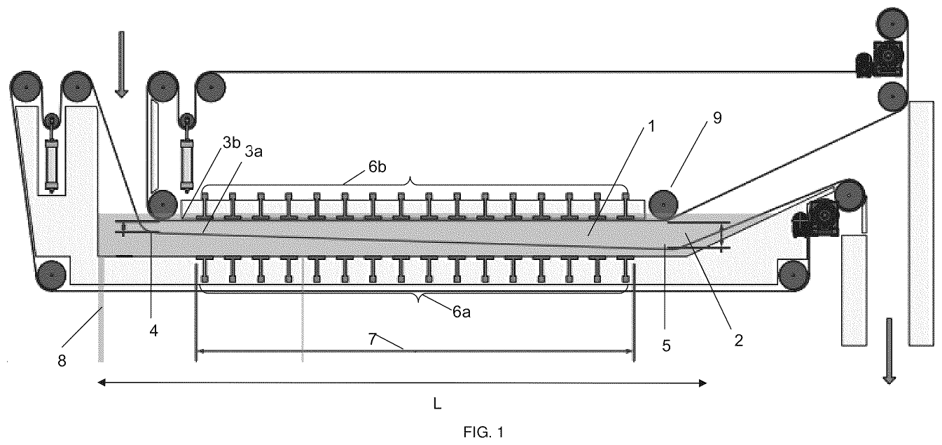

An Example apparatus of the present disclosure is described with reference to FIG. 1.

The apparatus comprises a reaction channel (1), wherein, in use, the channel is filled with brine (2). The channel has a length (L) of about 10 metres long (wherein length is defined as the length of the bottom of the channel). However, other suitable lengths may be used.

Disposed within the channel are two independent conveyor belts: a lower belt (3a), and an upper belt (3b) (which may otherwise be called first and second belts respectively). The belts are formed of a non-conductive PTFE (Teflon®-coated Kevlar mesh), however other suitable materials may be used. The belts have a width of 300 mm and a mesh aperture size of from 1 mm to 3 mm. In the channel, the lower and upper belts are arranged in top of one another with a spacing in between (i.e. for the biomass-composite material and slurry to reside). Both the lower and upper belts (3a) and (3b) feed into the channel to form an entry point (4). The two conveyor belts extend along the length of the channel and separate and feed out of the channel at exit point (5). The two conveyor belts are adapted to (i) feed the biomass composite material into the channel, (ii) move the slurry through the channel (i.e., from the inlet of the channel to the outlet of the channel), and (iii) raise the fibres out of the channel.

In use, biomass composite material is fed into the channel by lower belt 3a. The upper belt 3b also descends into the channel to sandwich or confine the biomass-composite material, to form an entry point (4). Since the channel is filled with brine, the lower belt 1a, upper belt 1b, and biomass composite material are submerged in the water.

The two conveyor belts move the biomass-composite material along the length of the channel (i.e. in the direction of the arrows (see FIG. 1)), wherein the belts are driven by a plurality of rollers (9). The two conveyor belts hold the slurry and biomass-composite material in place.

In the apparatus of FIG. 1, the distance between the two conveyor belts increases along the length of the channel, whereby the lower conveyor belt slopes downwards along the length of the channel. In use, this allows the material to expand as it is drawn through the apparatus. In this example apparatus, there is a distance of 200 mm at the entry point where the two conveyor belts feed into the channel (4), and 300-350 mm at the exit point where the two conveyor belts feed out of the channel (5). However, other suitable distances can be used.

Disposed above and below the channel is a series of electrodes (6a and 6b). In this example, the series of electrodes are arranged below (6a) and above (6b) the channel. The first electrode in the series to the last electrode in the series define an electrode region (7). The electrode region has a length (L_{E}) of about 5 metres long, however any suitable length may be used. The electrodes are stainless steel, but any conductive material may be used. Each electrode is in the form of a flat plate of size 30 mm×300 mm. While not shown in FIG. 1, power delivery to the electrodes can be optimized by use of control equipment, for example, comprising one or more thyristors or invertors. In use, an applied voltage is applied at the electrodes such that a current flows through the slurry and the biomass-composite material to heat the biomass-composite material. This causes the fibres to separate, caused by degradation of the chemical bonds in the biomass-composite material which hold the biomass-composite material together and/or degradation of the resin in the biomass-composite material.

In use, brine (2) is fed into the channel through a water feed system (8). While not shown, the operating level of the water (brine) is maintained by an automated system that continuously adds more water (brine) to the apparatus channel. The water fed into the channel can pass through the mesh conveyor belts and can be used to wet the biomass-composite material and/or replace water that is absorbed by the biomass-composite material. Water in the slurry between the two conveyor belts in the channel enables a conductive path to be formed between the electrodes.

While in FIG. 1, the distance between the belts increases along the length of the apparatus between the entry point and exit point, in other embodiments, the distance between the belts may remain substantially consistent across the length of the apparatus. Furthermore, while in this Example, the electrodes are arranged above and below the channel, the electrodes may additionally or alternatively be placed at either side of the channel.

While in FIG. 1, a mesh material is used for the belt, a non-meshed belt can be used, provided the biomass composite-material used is pre-wetted, or there is at least one opening for water to pass through the belt into the region between the two conveyor belts.

While not shown in FIG. 1, the apparatus may further comprise one or more baffles at inlet of the channel on each side of the lower belt 1a. This is to direct the material away from the edges of the belt (i.e., so that the belt is not filled to the edges) such that the biomass composite material does not overflow the edges of the belt.

While not shown in FIG. 1, the apparatus may further comprise the use of drivers and/or rollers, to support or increase the rigidity of the belt arrangement.

While not shown in FIG. 1, the apparatus may further comprise a tensioning system (e.g., a pneumatic, hydraulic, electrical or mechanical tensioning system) to achieve good tension between the belts, which can automatically adjust to the operating conditions such that the apparatus is sufficient to contain the biomass-composite material between the belts and transport the material through the channel as the belts move.

While not shown in FIG. 1, upstream of the channel, the apparatus may further comprise one or more of a mechanical breakdown module, a wetting module, or a pre-heating module. In some embodiments, the heating and wetting may take place in the same vessel in an integrated process.

While not shown in FIG. 1, after the conveyors exit the channel, the conveyors may comprise an elongated portion which allows water to drain prior to their separation. The drainage may be assisted by compression e.g., by a mechanical press.

While not shown in FIG. 1, after exiting the channel, the conveyor belts deliver the separated fibres to one or more of a deagglomeration module, cleaning module and/or a drying module. In some embodiments, the deagglomeration, cleaning and/or drying may take place in the same vessel in an integrated process.

While not shown in FIG. 1, excess water (from drainage or the drying module) can be removed and returned to the channel by a water recirculation unit. This water removal process may be beneficial because it allows electrolytes (if present) and water to be returned to the apparatus, and prevents dissolved contamination from entering subsequent processing steps. If the water is heated, this also provides a mechanism for returning heat to the apparatus. If the next stage is a drying step, this first water removal reduces the load, and hence the size and cost of subsequent drying apparatus. If the next processing steps are wet phase cleaning, removal of contamination can be important.

### Comparative Examples

The present inventors considered, designed or tested many other conveying systems in combination with an ohmic heating channel, but these were not found to be suitable. This is explained in more detailed below.
Pumping System—A pumping system was found to be prone to blockages and breakdown, namely because the system was not compatible with a feedstock that expands as the reaction proceeds. In order to reduce the extent of blockage and breakdown, a highly dilute slurry could be used, however a highly dilute slurry is very inefficient to process and ohmically heat.
Screw Conveyor System—Similar issues with expansion were observed for a screw-conveyor system. The screw conveyor system was found to be less compatible with a feedstock that expands as the reaction proceeds. Further, a screw conveyor system had issues with irregularly shaped input material that readily bridge within a pipe due to the Janssen effect. The Janssen effect describes the mechanical behaviour of particles within a confined geometry such as a column or pipe, whereby the frictional forces between the particles and the container wall leads to the material becoming immobile, behaving like a solid rather than a particulate mass, and hence preventing flow through the confined geometry.
Tubular Drag Conveyor System—A tubular drag conveyor system was not found to be suitable due to the limited capacity of the systems due to their intrinsic strength of cable design. There was further difficulty and incompatibility with this system handling the solid biomass composite material which would get wedged in the clearances between the discs of the tubular drag conveyor system.
Single Conveyor Belt System—While a single conveyor belt is routinely used for transporting material, this was not compatible for transporting a slurry comprising biomass-composite material and water. The single conveyor was found not to have sufficient drag force to pull the slurry through the reactor channel.
Pneumatic Air Conveyor System—A pneumatic air conveyor system is not suitable for use with liquids or water, and so the creation of a conductive path is not possible which precludes the use of ohmic heating.

### Detailed Example Processing Method

The example process method was carried out in an apparatus substantially similar to as described above, except that the electrodes were arranged at either side of the channel (as opposed to at the top and bottom of the channel).

MDF board feedstock is prepared by chipping the MDF into pieces approximately 30 mm-40 mm in length and width, and with 3-10 mm thickness. The MDF board feedstock contains between 85-95% wood fibres and 5-15% urea formaldehyde resin. The dry density of the MDF board feedstock is within a range of 750-850 kg/m³.

A brine solution is prepared with a conductivity 600 mS/m, and is heated to a temperature of 80° C. The channel is filled with brine solution. The operating level of water in the channel was above the level of the upper belt and was maintained by an automated system that continuously adds more brine to replace the water that is absorbed by the MDF chips.

Dry MDF chips are introduced into the channel, via the lower conveyor belt, at a rate of 150 kg per hour. The MDF chips are spread in an even layer across the lower belt, with an initial depth of about 50 mm. It is found advantageous to allow a gap at each side of the belt of approximately 25 mm so that as the material expands, it is less likely to overflow the edges of the belt. This can be achieved by using an apparatus with a baffle on each side of the belt at the inlet of the apparatus.

As the MDF material moves into the apparatus, the upper belt descends and restrains the material, and the whole arrangement is submerged into the brine. The twin-belt arrangement helps hold the wood chips in place and forces them to submerge, as they would otherwise naturally float. The slurry and biomass-composite material is moved through the channel at a rate of 5 mm/s. This ensures a high-density slurry since the two conveyors compress the biomass due to tension of the belts.

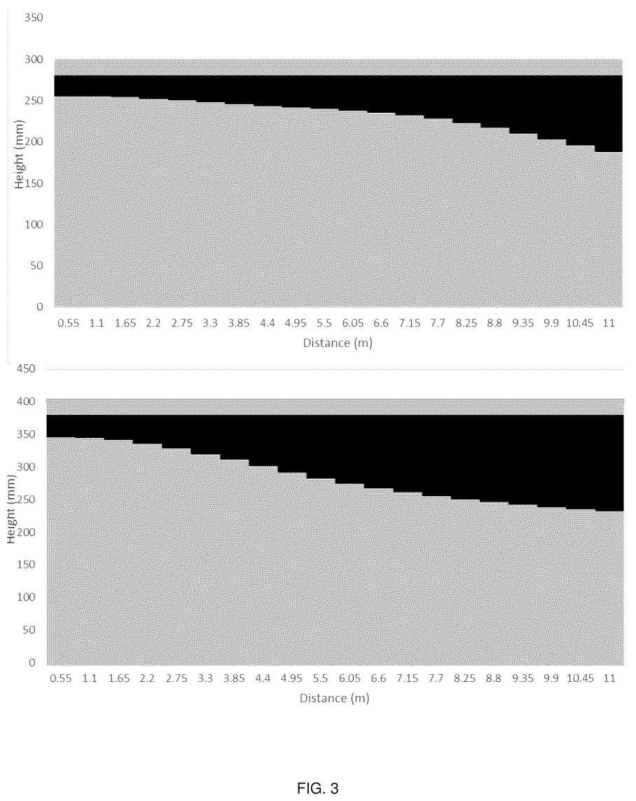

Ohmic heating is applied via an array of electrodes placed at either side of the material within the apparatus channel to achieve a stable operating temperature of about 80° C. In this example, a total power of about 50 KW is applied across the electrode array. In this example, the electrodes within the apparatus are segregated electrically into several groups, and the power input to each group of electrodes can be modulated in response to the varying requirements by pulse width modulation of the applied waveform. In this example, significantly more power, for example, around 75% of the total, is applied to electrodes positioned in the first half of the apparatus channel as compared to the second half of the apparatus channel. This is found to give a better result in terms of speed of processing the material. While this Example was used with electrodes placed at the side of the channel, modelling suggests that horizontally placed electrodes at the top and bottom of the channel could offer more efficient production and a lower energy burden (see FIG. 3 and Tables below).

Modelling of vertical electrodes
(e.g. electrodes at either side of the channel)
Outputs

| MDF flowrate | 108 kg/h | Energy Input | 328 kWh/t |
|---|---|---|---|
| Total Power | 35.4 kW | Power/Expansion | 8.92 kW m³/m³ |
| Power in MDF | 2.93 kW | Make-up water | 321 kg/h |
| Power in Water | 32.5 kW | Expansion Ratio | 3.97 |
| Current | 229 A | Water saturation | 46.1% |

Modelling of horizontal electrodes
(e.g. electrodes at the top and bottom of the channel)
Outputs

| MDF flowrate | 202 kg/h | Energy Input | 83 kWh/t |
|---|---|---|---|
| Total Power | 16.7 kW | Power/Expansion | 3.87 kWm³/m³ |
| Power in MDF | 3.77 kW | Make-up water | 669 kg/h |
| Power in Water | 12.9 kW | Expansion Ratio | 4.32 |
| Current | 167 A | Water saturation | 50.1% |

As the apparatus is running, the operator has to monitor the achieved composition of the product, in order to make adjustments to the processing parameters.

The power may be adjusted between 20-60 KW, typically 40 KW in order to achieve the desired degree of breakdown of the chemical bonds between the resin and fibres, or degradation of the resin. Alternatively or additionally, the conveyor speed may be adjusted from 1 to 12 mm/s, or the temperature can be increased up to temperatures of about 100° C. or decreased. The applied power and operating parameters may depend on the density of the composite material, the mass flow rate of the slurry (where a faster flow rate of the slurry may require more power being applied), the temperature of the slurry, and the amount of heat loss of the apparatus (which may depend on the geometry, insulation characteristics and external temperature of the apparatus). For example, a higher density of composite material typically requires more power being applied, while a higher temperature of the slurry may mean that less power or a faster flow rate can be used. In any case, the operator can monitor the composition of the product to make adjustments to the processing parameters. If the product has been minimally processed (e.g., there are pieces of unprocessed MDF chip in the product) and a higher degree of processing is required, then the applied power can be increased, the temperature can be increased, or the conveyor speed can be reduced, which has the effect of increasing the power delivered per unit of material to be processed. If the material is processed too much, (e.g., there is large expansion of the fibres and brine absorption into the wood fibres), then the opposite adjustments are made.

During processing, the chemical bonds between the resin and the fibres present in MDF breaks down and the wood fibres are released and/or the resin can degrade. This leads to conversion from solid MDF chips to wood fibres that form a spongy compressible matrix. This can result in an expansion of the material by a factor of about 5 times (the level of expansion depending on original MDF board quality and the processing conditions). Some of this expansion can be facilitated by the wood fibres filling the voids that were present in the original pile of MDF chips. The expansion can also be allowed by the flexibility of the belt system, while continuing to constrain the material and transport it through the apparatus. The expansion is also aided by the spacing between the belts increasing between the entry and the exit of the apparatus.

At the outlet of the channel, the two conveyor belts emerge from the brine and the upper belt separates from the processed material. Typically, as the wood fibres exit the apparatus channel, they are accompanied by about 600 kg of brine, which is partly absorbed into the material. The lower belt can deliver these fibres to a subsequent processing step.

In some embodiments, separation of the belts can take place after an elongated section of the two conveyor belts, to aid dewatering.

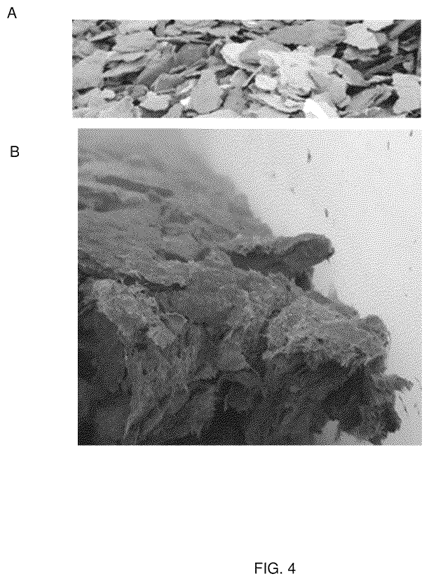

During processing in the apparatus, the MDF chips may have been reduced back to individual, wood fibres, or a clump of fibres, which exit the apparatus as a mat of material. Individual wood fibres can be recovered as they are no longer bound together by a resin. The consistency of the product can be varied by operating the equipment to achieve varying degrees of processing. FIG. 4 shows the transformation of MDF chips that are inputted into the apparatus (A), and after processing (B).

### End Results

With the minimum degree of processing (e.g., where the energy per unit mass of material to be processed is about 40 kWh/tonne), which would be most efficient in commercial operation, the end result is separated fibres which are clumped together in correspondence with the originally fed MDF chips, which grouping can be physically discerned in the product and individually handled as lumps of material. This type of material can be further broken down by light mechanical action, for example by mixing in water in an agitated vessel, or by a combing or beating type action on the bulk material.

With a higher degree of processing (e.g., where the energy per unit mass of material to be processed is about 80 kWh/tonne), the wood fibres are completely freed of their original association and it is not possible to discern any trace of the fed MDF chips. An essentially uniform mat of fibres is produced, with individual fibres readily available, either after drying or if the material is diluted in water.

1. An apparatus for recovering separated fibres from a biomass composite material, the apparatus comprising:
a channel configured to receive a slurry comprising a liquid medium and a biomass composite material
two or more conveyor belts configured to move the slurry through the channel, such that, in use, biomass composite material is disposed between the two or more conveyor belts, and
a plurality of electrodes disposed within the channel, the electrodes being configured to pass an electric current through the slurry to heat the biomass composite material, to effect separation of the fibres in the biomass composite material.

2. The apparatus according to claim 1, wherein the distance between the two or more conveyor belts increases along the length of the channel.

3. The apparatus according to any preceding claim, wherein the two or more conveyor belts are formed of a non-electrically conductive mesh material, and preferably wherein the mesh material comprises a polymeric material, and preferably wherein the polymeric material is selected from a para-aramid and polytetrafluoroethylene (PTFE), optionally a PTFE-coated para-aramid.

4. The apparatus according to any preceding claim, wherein, in use, the electrodes are arranged such that a first electrode is spaced apart from a second electrode to allow the slurry to pass between the first and second electrodes and the electric current to pass between the first and second electrodes, wherein, in use, the first electrode and second electrodes are disposed at different vertical heights within the channel and/or the first electrode is spaced apart laterally in the channel from the second electrode.

5. The apparatus according to any preceding claim, wherein the electrodes are arranged into at least two groups along the length of the channel, wherein each of the groups are configured to pass different levels of current through the slurry along the length of the channel.

6. The apparatus according to any preceding claim, wherein the apparatus comprises at least one baffle at a side of channel between the two or more conveyor belts.

7. A method of recovering separated fibres from a biomass composite material, the method comprising:
providing a slurry comprising a liquid medium and a biomass composite material;
moving the slurry through a channel using two or more conveyor belts, wherein the biomass composite material is disposed between the two or more conveyor belts; and
passing an electric current through the slurry while the biomass composite material is between the conveyor belts to heat the biomass composite material, to effect separation of the fibres in the biomass composite material; and
recovering the separated fibres.

8. The method of claim 7, carried out using the apparatus of any one of claims 1-6.

9. The method of any one of claims 7-8, wherein the biomass composite material is heated to between 5° and 100° C., and preferably between 75° C. and 100° C.

10. The method of any one of claims 7-9, wherein the slurry is provided by feeding the biomass-composite material into the channel and wetting the biomass-composite material with water in the channel.

11. The method of any one of claims 7-10, wherein the belt speed is within a range up to 100 mm/s, preferably between 2 mm/s to 50 mm/s.

12. The method of any one of claims 7-11, wherein the biomass composite material is shredded into pieces, preferably wherein at least some of which are 1045 mm along their longest dimension.

13. The method of claims 7-12, wherein the liquid medium comprises or is water.

14. The method of claim 13, wherein the water further comprises an electrolyte, preferably wherein the liquid medium comprises or is brine.

15. The method of any one of claims 7-14, wherein the ratio of liquid medium to biomass-composite material in the slurry is from 20:1 to 1:1 by weight, optionally 15:1 to 1:1 by weight, optionally 8:1 to 2.5:1 by weight.

16. The apparatus of any one of claims 1-6, or the method of any one of claims 7-15, wherein the biomass composite material comprises ligno-cellulosic fibres.

17. The apparatus of any one of claims 1-6, or the method of any one of claims 7-16, wherein the biomass composite material is an engineered wood material and the fibres are wood fibres.

18. The apparatus or method of claim 16, wherein the biomass composite material is selected from softboard, MDF, HDF and particleboard.
